(19) United States
(12) Patent Application Publication
(10) Pub. No.: US 2011/0066643 A1
(43) Pub. Date: Mar. 17, 2011

(54) SYSTEM AND METHOD FOR ASSEMBLING, VERIFYING, AND DISTIBUTING FINANCIAL INFORMATION

(76) Inventors: John COOPER, New York, NY (US); Stefan Lehmann, Hastings on Hudson, NY (US); Michael Mellinger, Hoboken, NJ (US)

(21) Appl. No.: 12/560,491

(22) Filed: Sep. 16, 2009

(51) Int. Cl. G06F 7/10; G06F 17/30

(52) U.S. Cl. 707/770; 707/E17.044; 707/E17.108

(57) ABSTRACT

A method and system may allow inputting data into a database of financial information from multinational sources (e.g., in the form of documents), and searching over that data. One agent may add or upload a document relating to a corporation, metadata for the document may be generated, and another agent may validate the metadata or the document. Based on the document type, the document may be divided into portions and tagged. An automatic process (e.g., a “crawler”) may collect documents on corporations. A user may search over the documents, where the original documents are in a language different from the user's search language.

### BACKGROUND

Current systems and method for collecting, organizing and distributing financial information are limited. Current systems do not easily integrate highly relevant information from multiple markets in different countries, having different original languages and formats. Leading financial information vendors lack coverage on a significant amount of information, in particular qualitative information, in a majority of the financial markets around the world. Having investors themselves, who might be customers of existing financial information systems, collect, organize, and translate (if needed) such information is inefficient, may produce poor results, and duplicates efforts. Investors may not know that certain information exists.

### SUMMARY

A method and system may allow inputting data into a database of financial information from multinational sources (e.g., in the form of documents), and searching over that data. One agent may add or upload a document relating to a corporation, metadata for the document may be generated, and another agent may validate the metadata or the document. Based on the document type, the document may be divided into portions and tagged. An automatic process (e.g., a “crawler”) may collect documents on corporations. A user may search over the documents, where the original documents are in a language different from the user's search language.

One embodiment of the invention includes a method of inputting data into a database of financial information from multinational sources, the method including receiving at a database, from a first human agent, a document relating to a corporation; providing, at a user interface, a list of document types, and receiving, from the first agent, a document type for the document and a document date for the document; generating at a user interface, metadata for the document, the metadata including at least a title, the title generated at least in part from the document type and document date; receiving at the user interface, an indication that the first agent is finished inputting the document; providing, via a user interface, the document and the metadata to a second agent; receiving, at the user interface, an indication of validation (e.g., from the agent) of the metadata entered by the first agent; and after receiving indication of the validation, allowing the document to be viewed by a user via the database, wherein the database contains documents relating to corporations in a plurality of countries, and wherein the database contains documents in a plurality of languages. The database may include information on a plurality of corporations, and method may include the user interface permitting the first agent to enter information relating to a first subset of corporations and to validate information relating to a second subset of corporations, the first subset and second subset being non-intersecting; and the user interface permitting the second agent to enter information relating to a third subset of corporations and to validate information relating to a fourth subset of corporations, the third subset and fourth subset being non-intersecting; wherein the first subset and fourth subset partially intersect. After the indication that the first agent is finished is received, the second agent may be notified that the document is ready for validation. A portion of the metadata may be in a first language which is different from the language of the document, and the method may include translating the metadata to a second language and presenting the metadata to a user in the second language.

One embodiment of the invention includes a method of inputting data into a database of financial information from multinational sources, the method including at a first computer, accessing a first remote database record at a second computer; at the first computer reading the first record to determine a first record type; at the first computer, based on the first record type, dividing the first record into portions, and tagging each portion with a field identifier from a set of field identifiers; at the first computer, saving the portions in the database of financial information; at a third computer, accessing a second remote database record at a fourth computer; at the third computer reading the second record to determine a second record type; at the third computer, based on the second record type, dividing the second record into portions, and tagging each portion with a field identifier from the set of field identifiers; at the third computer, saving the portions in the database of financial information; wherein the first record is in a first language, the second record is in a second language, and the field identifiers are in a third language. The first computer may include a list of target addresses, and the method may include, at the first computer, accessing for each computer a remote computer corresponding to the target address to access a database record. The first computer may include a stored date indicating when the remote database record at the second computer should be accessed. The field identifiers may be saved as metadata at the first computer.

One embodiment includes a system including a database of financial information from multinational sources; a first computer to access a first remote database record at a second computer, to read the first record to determine a first record type, to, based on the first record type, divide the first record into portions, and tag each portion with a field identifier from a set of field identifiers, and to save the portions in the database of financial information; a third computer to access a second remote database record at a fourth computer, to read the second record to determine a second record type, to, based on the second record type, divide the second record into portions, to tag each portion with a field identifier from the set of field identifiers, to save the portions in the database of financial information; where the first record is in a first language, the second record is in a second language, and the field identifiers are in a third language.

One embodiment of the invention includes a method of inputting data into a database of financial information from multinational sources, wherein the database contains documents relating to corporations in a plurality of countries, and wherein the database contains documents in a plurality of languages, the method including providing to a representative of a corporation a key; associating, at a computer system, the key with an Internet domain name assigned to the corporation; receiving at the computer system the key, and if the key is received via a communication channel associated with the domain name associated with the key, allowing the representative to proceed to transmit to the computer system a document relevant to the corporation; adding the document to the database; allowing the representative to view a second document maintained by the computer system, the second document being uploaded by a first analyst and the second document having been sent to a second analyst for verification; receiving from the representative, before the second analyst verifies the second document, an indication that the second document and metadata attached to the second document is accurate. The method may include accepting from a user a search query; applying the search query to the database; and providing a list of documents based on the query. The document (or the documents in the database) may be in a first language, and the search query may be in a second language.

One embodiment of the invention includes a method including receiving, via for example human agents and via automated web-crawlers (and possibly other methods), at a database a plurality of documents relating to a plurality of corporations, each of the documents written in a language, wherein the documents are written in a plurality of languages; creating for each document a set of metadata in one standard language (e.g., a human written language such as English or Russian); receiving, via a user interface operated by a computer remote from the database, a search request from a user, the search request being in the standard language; applying the search request to the metadata; providing a list of documents matching the search results to the user; receiving an indication from the user of a document to be displayed; if the document is in a language other than the standard language, querying the user if the user wants a translation; and if the user indicates, via the user interface, that the user wants a translation, creating a computer-generated translation and providing the translation to the user. The database may include a plurality of sets of search metadata, each set of search metadata being in a different language. The method may include charging a fee for the translation, the fee based on an expected demand for the document. The metadata may include section tags, each section tag indicating a section of an original document, the original document being a remote document at a corporation database from which a document in the database is derived.

Embodiments of the invention include systems implementing the various methods disclosed herein. The systems may of course implement other methods as well.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic illustration of a financial information collection and distribution system, in accordance with an embodiment of the invention;

FIG. 2 depicts a server according to one embodiment of the present invention;

FIG. 3 depicts an set of user, agent, and company computers according to one embodiment of the present invention;

FIG. 4 depicts an automated data gathering module according to one embodiment of the present invention;

FIG. 5 is a flowchart of a method for agents or analysts to populate a database with documents and verify the documents according to one embodiment of the invention;

FIG. 6 is a flowchart of a method for attaching metadata to documents maintained by a server maintaining a financial database according to one embodiment of the invention;

FIG. 7 is a flowchart of a method of allowing a corporate or other entity representative to upload and verify documents in a database of financial records, according to one embodiment of the invention;

FIG. 8 is a flowchart of a method of allowing a user, such as a customer subscribing to a financial documents service, to access documents in a database of financial records, according to one embodiment of the invention;

FIG. 9 is a screenshot showing a graphical user interface (“GUI”) that may be presented to a primary analyst or verification or validation analyst, according to an embodiment of the invention;

FIG. 10 is a screenshot showing a GUI that may be presented to a user, such as a company representative (or an agent working for an organization operating a server), showing documents relevant to that company, according to an embodiment of the invention;

FIG. 11 is a screenshot showing a GUI that may be presented to an agent or analyst working for an organization operating a server, showing documents relevant to a specific company, according to an embodiment of the invention;

FIG. 12 is a screenshot showing a GUI that may be presented to a user (e.g., a primary analyst) information (e.g., metadata) relating to a document according to an embodiment of the invention;

FIG. 13 is a screenshot showing a GUI that may be presented to a user (e.g., an analyst) showing events related to a company according to an embodiment of the invention;

FIG. 14 is a screenshot of a search tool allowing agents or other users to search documents, for example documents for which the agents are responsible for, according to an embodiment of the invention;

FIG. 15 is a screenshot showing a GUI that may be presented to an agent or analyst working for an organization operating a server, showing documents relevant to a specific company, according to an embodiment of the invention; and

FIG. 16 is a screenshot showing a GUI that may be presented to a primary analyst when creating or inputting a new document, according to an embodiment of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

The processes presented herein are not inherently related to any particular computer, network, or other apparatus. Various general-purpose systems may be used with programs in accordance with the teachings herein, or it may prove convenient to construct a more specialized apparatus to perform embodiments of a method according to embodiments of the present invention. Embodiments of a structure for a variety of these systems appear from the description herein. In addition, embodiments of the present invention are not described with reference to any particular programming language. A variety of programming languages may be used to implement the teachings of the invention as described herein.

Unless specifically stated otherwise, as apparent from the following discussions, throughout the specification discussions utilizing terms such as “processing,” “computing,” “calculating,” “determining,” or the like, refer to the action and/or processes of a computer or workstation, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may manipulate data representations of real-world entities such as corporations or other business entities, securities, funds such as for example mutual funds, reports (e.g., balance sheets, cash flow statements, income statements), news reports or recordings, conversations, transcripts, presentations (whether actual recordings of presentations or documentary summaries or transcripts of presentations), public events, or other data, representing these as internal data objects. Additional real-world entities represented as data in an embodiment of the invention may include securities (including, e.g., mutual funds, exchange traded funds (“ETFs”), stocks, bonds, or other securities), derivative products, REITs, cash or currencies, or securities related to cash or currencies. Embodiments of the invention may process and organize this data representing real-world entities, allow a user to access or search the data, and present the data to a user.

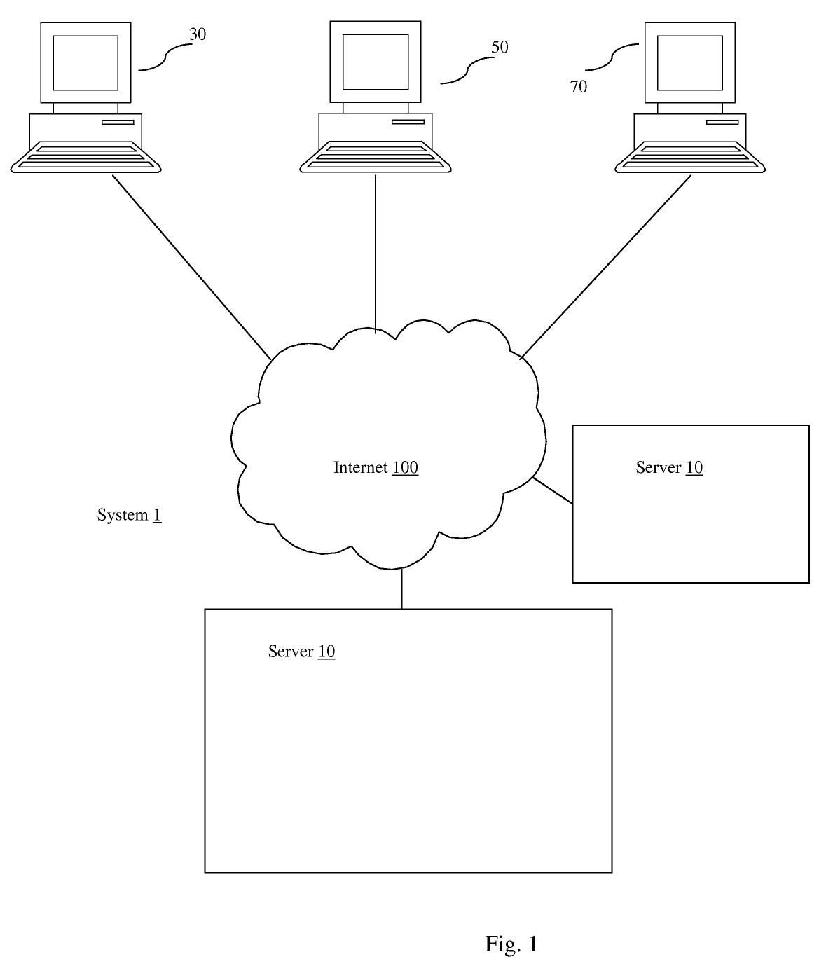

FIG. 1 schematically illustrates a financial information collection, verification, and distribution system in accordance with an embodiment of the invention.

A financial information system 1 may include one or more host server(s) 10 that may collect, store, organize, and present information such as data describing (e.g., qualitatively) corporations or other entities. Server 10 may communicate with users (e.g., clients of an organization operating server 10) requesting information, agents gathering and inputting information, and corporations, companies, or other organizations inputting information (and monitoring information), via for example one or more user computers 30, one or more agent computers 50, and one or more company or corporation computers 70. Communications among server 10 and computers 30, 50 and 70 may be through one or more communications networks such as Internet 100. Typically, computers 30, 50 and 70 are remote (e.g., located at a different site) from server 10. In one embodiment, analysts or agents are associated with an organization which operates server 10 and which provides services via server 10, the analysts or agents performing tasks such as for example gathering, validating or verifying data to be input into database(s) 24 maintained by server 10. In other embodiments, analysts or agents need not be used, and analysts or agents may have other functions and other relationships with server 10. Since many agents or analysts, end-users or customers, and corporations may access server 10, many computers 30, 50 and 70 may be used.

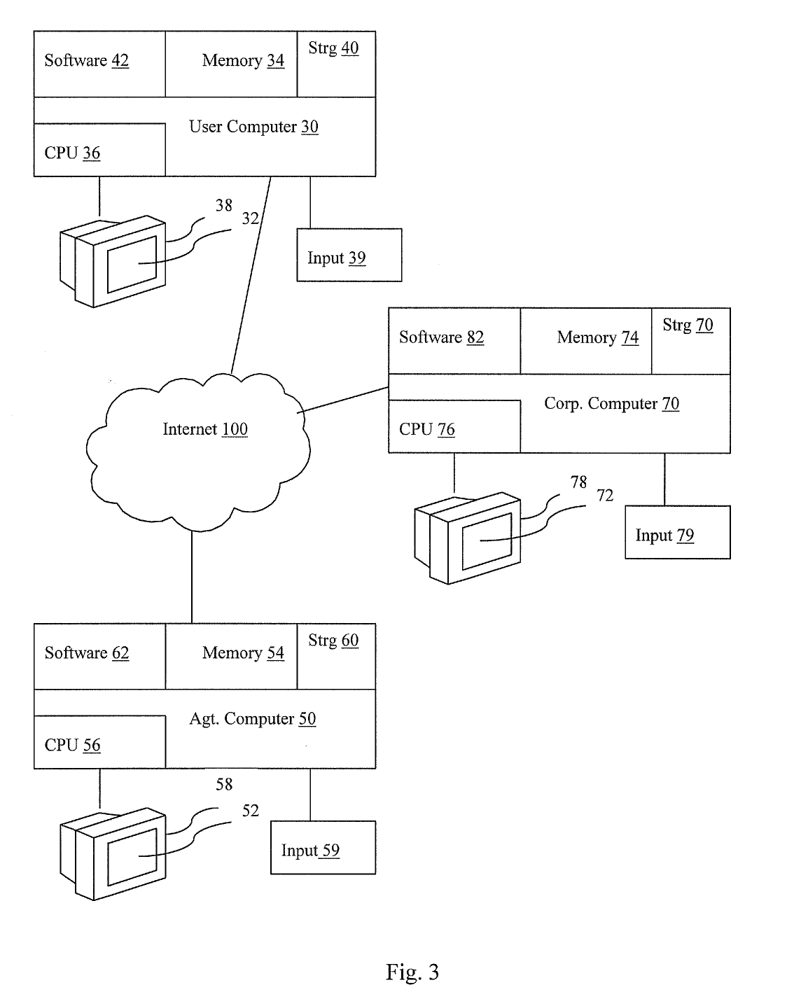

Server 10 may generate and support client side interfaces, for example, graphical user interfaces (GUIs) 32, 52, and 72 (FIG. 3). Server 10 may have two-way connections such that server 10 may read input and write output, for example, from and to computers 30, 50 and 70 via GUIs 32, 52, and 72 using one or more communications networks such as Internet 100.

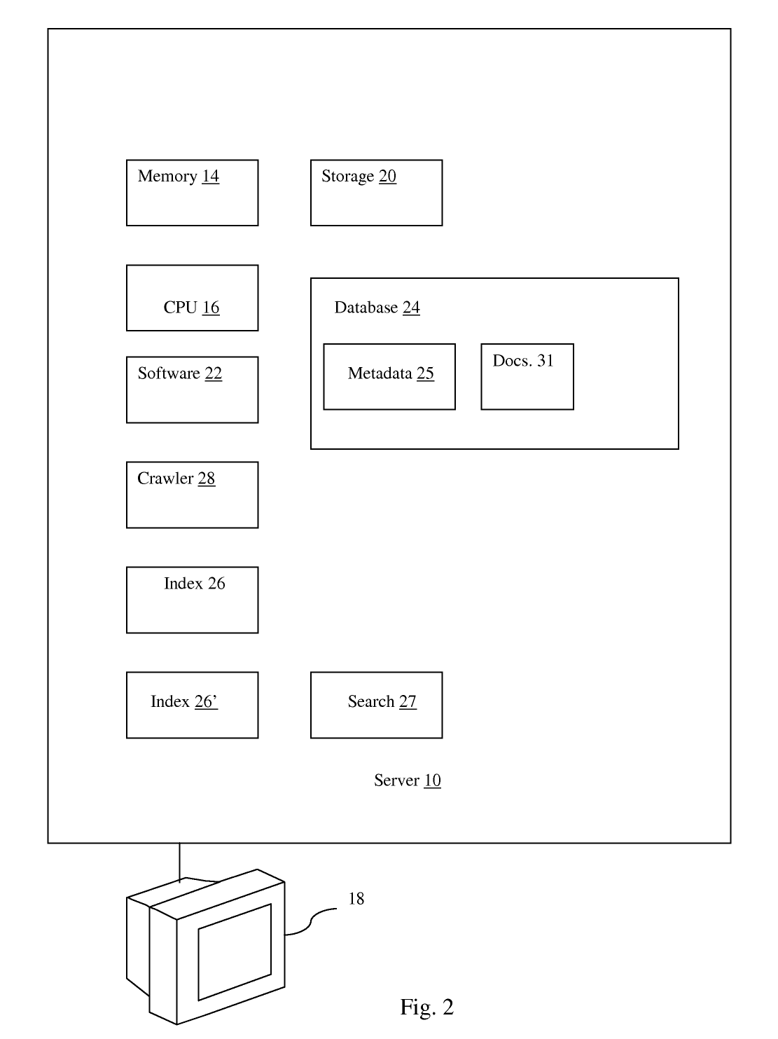

FIG. 2 depicts a server according to one embodiment of the present invention. Server 10 may be or include one or more computers, and may include for example a memory 14, a processor 16, a monitor or output device 18, a mass storage device 20, and software 22 (e.g., code and instructions that when executed by a processor such as processor 16 causes the processor to accept, organize, and present financial document information, to operate a GUI, Internet or network support software or other suitable software). Processor 16 may for example operate automated data gathering processes to gather data for server 10. Server 10 may execute or operate an automated software agent or “crawler” 28 which may, for example, obtain documents automatically, via a network such as the Internet 100. Crawler 28 may be executed by or operated on other components, such as agent computer 50 or another computer. Server 10 may include other components and capabilities.

Server 10 may include one or more databases 24 storing, for example, customer information (e.g., login, account information), agent information, financial information or documents 31 relating to entities such as corporations, companies, or other organizations around the world, and metadata 25. Databases 24, or information described in one embodiment as being in databases 24, may be or include relational databases or other databases, may be maintained remotely from server 10, and may for example be partially maintained by or duplicated by for example computers 30, 50 or 70. Databases 24 may include or be associated with an index 26 which may enable searching of the databases for documents. A parallel index 26′ may be included, in a language other than that of index 26, in order to allow users fluent in the other language to more easily search. Server 10 may include or support a search engine 27, which may be for example software or code stored in a memory (e.g. memory 14) and executed by, for example, processor 16. In one embodiment the search engine or tool 27 is provided by “fast” (http://www.fastsearch.com/), but in other embodiments other search tools may be used. Search engine 27 may, via for example a GUI, allow a user or another person (e.g., an agent or analyst, or another person working on behalf of the organization managing server 10), to search over documents stored or managed by server 10.

While various structures and modules such as search engine 27, databases 24, and memory 14 are shown as being part of server 10, the actual arrangement may differ, and some of these structures may be partially held or represented in others. For example, search engine 27 or crawler 28 may be software code (e.g. software code 22) stored partially in memory 14 and/or storage 20. For another example, indexes 26 and 26′ may be stored in database(s) 24 which also may be stored partially in memory 14 and/or storage 20.

When used herein, when referring to documents, language generally refers to a spoken or written language (e.g., English, Russian, Portuguese). In some embodiments metadata 25 may include words or data in spoken or written languages and/or codes or other non-conventional languages (e.g., tags, field identifiers or codes identifying document types or sections). Software or code, when referred to herein, is typically written (at the source code level and executable code level) in a computer language.

Metadata 25 may include data such as data categorizing or characterizing documents in documents 31 (e.g., titles, types, categories), data organizing documents (e.g., tags or field identifiers denoting different sections of documents), or other data. Documents when stored within documents 31 may be reformulated, reconstituted, or re-ordered from the document in its original form. In some embodiments, the position of certain sections of documents within a document record in documents 31 may in itself indicate the content of the section: for example a document section or portion placed within a first position may be known based on the position to be an “introduction.” In addition or separately a tag (e.g., part of metadata 25) may be applied to document sections to identify sections. Both tagging and position information may be used for redundancy. A set of tags or field identifiers, e.g. a set of possible tags to be used when dividing or tagging documents, may be stored at server 10.

In some cases, one server 10 or an associated database 24 may be located within a certain country if certain data cannot be exported out of the country or must be stored in the country.

Server 10 may use various operating systems, for example the Sun Solaris operating system or the Linux operating system, or other suitable operating systems. The various modules (e.g., crawlers, GUIs) may be implemented with various programming languages, such as for example, the Groovy programming language, the Java programming language, the Grails framework, the Perl programming language, the Python programming language.

FIG. 3 depicts a set of user, agent, and company computers according to one embodiment of the present invention. Each of user computer 30, agent computer 50, and corporation computer 70 may include for example memories 34, 54, 74, processors 36, 56, 76, monitors or output devices 38, 58, 78, input devices 39, 59, 79 (e.g., keyboards, mice, pointing devices, etc.), mass storage devices 40, 60, 80, and software 42, 62, 82 (e.g., code and instructions that when executed by a processor causes the processor to accept or display e.g. financial information, to operate a GUI (e.g., GUIs 32, 52, and 72), to perform method described herein, or to perform other operations). Computers 30, 50 and 70 may be for example personal computers, workstations, or simple terminals. Computers 30, 50 and 70 may include other components and capabilities.

In one embodiment, customers or users (e.g., corporations, agents) may have individual, personal or private accounts, which may include reports or histories that may be stored on server 10. In one embodiment, accounts may be accessed by codes, passwords, serial numbers or any other suitable forms of identification.

Database 24 may store records or documents 31 such as information relating to, describing, and helping to evaluate entities such as corporations, companies, or other organizations, the entities being from a variety of different countries, and the information being in a variety of different formats and languages (other and additional data may be stored). When used herein, a record or document stored relating to a corporation may include a text document, a graphical document (e.g., a .pdf, .jpg or other document), a presentation mixing text and graphics (e.g., a .ppt document), an audio file, a video file, or any other suitable file. For example, database 24 may store, relevant to different corporations, in different countries, balance sheets, cash flow statements, income statements, corporate filings, regulatory financials, audit reports, exchange filings corporate actions, announcements, press releases, news reports or recordings, press releases, conversations, transcripts (e.g., call transcripts, earnings call transcripts, proceedings of annual meetings, or recordings of these events), management guidance, sales forecasts, presentations (e.g., management presentations, earnings presentations, business-line presentations, product presentations, and recordings of presentations or documentary summaries or transcripts of presentations), information on public events, etc. The records or documents when stored in database 24 may be copies of the originals or copies (e.g., paper or electronic) stored at the data sources. The language of the data may differ depending on the country from which it was gathered, and the format of the report may differ depending on the country from which it was gathered. For example database 24 (possibly in the form of rules for a crawler) may include a document or table which, for certain types of documents to be stored in database 24, correlates the location or description of sections in source documents from different international sources to the document as it is to be stored in database 24. A document or table may correspond the SEC-filing equivalents in all certain foreign jurisdictions to the same type of document as stored in database 24. For example, “Insider Filings” (e.g., Forms 3, 4, and 5) are equivalent to Comissão de Valores Mobiliários (CVM, a financial regulation agency of Brazil) Filing 358.

Data may be input into database 24 in various ways, verified or confirmed, and users may access this data. Typically, while original versions of the documents exist at their source site (e.g., a company web site, or a government database), a copy of the document is created and stored in database 24.

Documents 31 stored in database 24 may be in various languages, collected from various different countries. In addition, documents 31 may have different organizational formats, and may have different types of metadata (if any) attached to or associated with the documents. Some metadata 25 may be associated with the document when the document is input into the system, before processing. Metadata 25 may be created and attached to documents so that the documents may be easily organized and searched. For example, a title and date may be added as metadata 25, the document may be assigned a type or category (e.g., financial statement, news, presentation, transcript), a source link (e.g., the Uniform Resource Locator (URL) pointing to the original document) may be added, and sections of the document may be tagged.

The sections or tags of a document may vary by the type of the document.

For example, for documents having the type Offering Documents, Annual or Interim Filings, the sections to be tagged may include:
Business Overview/Introduction
Risk Factors
Management's Discussion & Analysis
Material Events/Subsequent Events
Management and Board of Directors
Significant Shareholders
Capital Structure
Board of Director's Report/Corporate Governance Overview
Auditor's Letter/Report
Financial Statements
Footnotes to Financial Statements

For documents having the type Call Transcripts or Recordings, the sections to be tagged may include:
Introductory Remarks/Overview
Management Discussion—Operations
Management Discussion—Finance
Q&A

For documents having the type Earnings Press Releases, the sections to be tagged may include:
Introductory Remarks/Overview
Summary Financial Statements.

Other data may be included in documents. Other documents and document types may include, for example:
Financial Filing (sample sub-types including annual report, and interim report, and other);
Press Release, Presentation, Conference Call Transcript or Conference Call Recording (sample sub-types including earnings, company overview and other);
News Item;
Filings & Financials (sample sub-types including annual report to shareholders, annual report as filed, interim report as filed, financial statements, offering documents, significant shareholders and insiders, material events and notices, corporate formation documents, and other);
Meetings and Minutes (sample sub-types including Board of Directors/Executive Board Meeting, and General Shareholders Meeting);
Other; and
Unknown.

Typically, the metadata 25 is in one standard language across the system, such as English. This may allow users knowing the standard language to search over a set of documents which are in a variety of languages. A document description may be presented to a user, e.g., as a summary instead of the document, the document description including metadata. Metadata 25 may be translated to another language and possibly stored in database 24 so that users fluent in a language other than the standard language may use and search over the documents. If metadata 25 is translated to a certain language index 26 may also be translated to that language to enable fast searching in the language In addition, the documents may be processed or altered from their original form in other ways. The language of the original document may be called the “local language” or the “native language”, and in some embodiments searching may be done in the local language and in one or more standard languages used by the system. Documents in several “local languages” may be input into the system.

Typically GUI 32 operates in a first language, which is the language of metadata 25 and index 26. In some embodiments, the GUI 32 and search and presentation capabilities may be presented to different users in different languages. In such a case the metadata 25 and index 26 may be translated to a second language, and a GUI 32 may be presented to a user in that language. The user may search the translated metadata 25 using the translated index 26, and the metadata translated into a second language may be presented to a user (e.g., when a document description is presented to a user, the document description including metadata).

Various processes may input documents into database 24. The documents may be copied from their sources (e.g., corporate or government databases), and thus the same document may occur in one version in database 24 and in its original version a corporate or government database. The document when in database 24 may be derived from or copied from the original database. Metadata added to or augmenting a document in database 24 may for example indicate a section of the original document in the corporate or government database, or indicate correspondence of sections from the copy of the document to the original document.

Analysts or agents, possibly affiliated with server 10 (e.g., working with or for an entity controlling server 10) may input data into database 24, e.g., via computer 50. Automated data gathering processes (e.g., crawlers, such as crawler 28), may gather information from remote databases, websites, or other sources, and input. Such automated processes may be executed by server 10, but may be processes operating or executed remotel from server 10. Information (e.g. documents) relating to an entity (e.g. corporation, company, or other organization) may be posted to or added to database 24 by the entity which the information describes. For example, a representative of a corporation may upload data relating to that corporation to server 10. Data gathered through these methods may be input temporarily or permanently into another database associated with server 10.

Users who may be customers of the entity controlling or managing server 10 may want to access information on corporations in different countries. Users may access this information in different ways. For example, a user may request, via GUI 32 presented on a user computer 30, information on corporation X. A user may search for all information in country Y relating to, for example, tax penalties, and see a result of documents stored in database 24 relating to this search.

### Data Collection in Conjunction with Analysts

In one embodiment, a server 10 may generate GUI(s) 52 which may be displayed on monitor 58 by, for example, a browser operating on analyst or agent computer 58. For example, the Mozilla Firefox browser, or other suitable browsers, may be executed on computers 30, 50 and 70 to provide a display which may be originally generated by server 10, allowing agents, analysts, or users to communicate with server 10. Agents or analysts may for example enter information via for example input device(s) 59 and view information on monitor 56, via for example GUI 52. The GUI 52 may in some embodiments be termed a “dashboard”, and may be executed by for example processor 56, but may be originally generated by server 10. The GUI 52 (or multiple GUIs) may allow analysts or agents to enter or upload information, such as documents to a database such as database 24. The GUI may allow analysts or agents to validate or verify or check the accuracy of documents or metadata added to documents uploaded, or ready to be uploaded, to database 24. An agent or analyst may be required to log in using for example an identification and password before inputting data. A record may be kept for each upload analyst as to how many or what percentage of documents uploaded for that analyst needed to be corrected.

An analyst or agent may upload a document via for example GUI 52. Metadata (e.g., metadata 25) may be created for the document and stored in a database (e.g., database 24). The metadata for a set of documents may be stored separately from the documents, or each set of metadata for an individual document may be stored with the document. An analyst or agent may validate or verify the upload of document and the metadata created also via for example GUI 52 (alternately, different GUI's may be used to upload and validate or verify data).

In one embodiment, for each document, a first agent or analyst, e.g., a primary analyst, uploads or enters the document and a second analyst, e.g., a verification or validation analyst, validates the data. While typically the primary, uploading analyst is a different person from a validation analyst, in other embodiments they may be the same. The primary, uploading analyst may be organizationally separate (e.g., in a different physical office) from a validation analyst. In one embodiment, one analyst may act as primary/uploading analyst for documents to be entered from a first set of companies, and that same analyst may act as a validation analyst for documents to be verified for a second set of companies, the two sets non-intersecting. In one embodiment two analysts may be paired, in that each analyst validates documents uploaded by the other. In other embodiments, a team of analysts may be assigned the same functions, and thus one team of analysts (a team including a number of individuals) may perform upload analyst duties for a set of companies and validation analyst duties for another set of companies. In other embodiments, each analyst may perform only one role, e.g., an analyst may perform upload duties without validating, or validation duties without uploading. Auditing personnel or analysts may spot-check or otherwise analyze document uploading that has been verified by verification analysts.

In the event that a validation agent or analyst assigned to a certain company is not available (e.g., is on vacation, is sick) and a document needs to be validated for that company, server 10 may assign the validation to another, temporary, validation agent. In other embodiments, multiple validation analysts or agents may validate the same document, and a process may determine the validity of the document or metadata based on a combined result. Typically, permissioning of analysts (e.g., that analysts cannot access documents for entities not assigned to them) and division of primary analyst and validation analyst responsibilities, is enforced by server 10, via GUIs 52. For example, a set of rules and data stored in database 24 may cause server 10 to allow a first analyst to analyze upload and analyze data from a first set of companies and may notify a second analyst regarding validation tasks for that set of companies. Other agent organizational schemes may be used.

The server 10 via GUI 52 may prevent an agent or analyst from having certain access to documents related to companies that agent is not associated with. For example, an agent or analyst who is a validation analyst for a first set of companies and primary analyst for a second set of companies may not have validation access for any company not in the first set and may not have upload access for any company not in the second set; the agent cannot validate his or her own documents, and cannot have any access to documents not in either set. Other “permissioning” protocols may be used.

Typically, the metadata is in one language, such as English, while the documents themselves may be in various languages, English and non-English, and may be in various different formats. Due to the nature of language, some small portion of the metadata may vary from the standard language (e.g., be non-English) due to imported phrases and names. Thus the document to be uploaded by the agent may be in a language different from the standard language of the metadata; for example the document (and any original metadata associated with the metadata) may be in Portuguese, and the standard language of the system and metadata may be English. The GUI 52 may allow the analyst to upload the document to the server 10.

The GUI 52 may allow the analyst to tag the document or add metadata to the document. For example, the GUI 52 may present to the analyst a set of documents types, and the analyst may enter or pick a document type for the document. When the agent or another person enters data to the GUI, it can be said that the GUI (or the computer executing the GUI, or the server providing the GUI) accepts that data from the agent. In some embodiments, this choice of document type may affect other metadata or tag choices presented to the analyst, or may for example cause the GUI 52 to automatically generate all or part of a document title.

The GUI 52 may accept from a user or allow an agent to enter a date for the document. The GUI 52 may use the date to automatically generate part of the title. In some cases, the exact date is not entered into the title, but rather a period of time. For example, Jan. 24, 2008 may appear in the title as “Q12008” or “Jan08”.

The GUI 52 may accept from a user or allow an agent to enter or edit a title for the document. The title may be partially generated by the GUI 52. GUI 52 may present a title created in part from other metadata, and the user may be permitted to modify the title. In other embodiments, a user may not be allowed to modify the title.

The GUI 52 may accept from a user or allow an agent to enter a comment for the document, possibly to be used internally, for example within an organization operating server 10.

The functionality of the GUI 52 may be effected by a processor executing code, for example processor 16 and/or 56, or other processors. Thus the GUI 52 accepting data may allow the server 10 or computer 50 to accept that data.

After the analyst finishes creating the metadata, the GUI 52 may accept a completed or finished indication from the analyst; e.g., the analyst may input a “finished” or “done” or check an appropriate box on GUI 52. This may end the upload process, and the server 10 may then start a validation process. The GUI 52 may indicate to a validation analyst or agent that the document is ready for validation. For example, the document may appear on a list of documents to be validated by the validation analyst, the document's status on a list accessible by the validation analyst may change, or a “pop-up” or other attention-getting message may appear to the validation analyst.

GUI 52 may display data and accept inputs allowing an analyst or agent to validate the document and data entered for the document. For example a validation analyst may check, via data displayed on GUI 52, that the document uploaded by the primary analyst is itself a valid document; e.g., it is what it purports to be, has the correct title, describes the proper entity, and/or that the metadata entered by the primary analyst for that document is correct. If any of the data is not correct or the document is not a valid document, the validation analyst may edit or correct the metadata or document organization, delete the document or add a new document with metadata, and then mark the document as validated. If the data is correct and the document is a valid document, the validation analyst may validate the document. The validation analyst may provide an indication to or enter data on GUI 52 indicating the document is valid.

An analyst may reorder or reconstitute a document as a crawler may, as described below. For example, an analyst may break up a document and reorganize, reformulate or reconstitute the document, or divide the document into tagged portions. The document may be reformed by an analyst into a standardized format used by server 10.

While, in one embodiment, a GUI 52 is described as inputting or accepting data from analysts, server 10 and computer 50 may communicate with users (e.g., display data to and input data from) in other ways, via other interfaces.

After the validation agent or analyst validates the document the document may be made available to end-users using server 10 via, for example, computers 30. In some embodiments, the metadata and possibly the text of the document itself may be indexed, and the indexing data added to index 26. For documents that are partially or primarily graphical, e.g., in .pdf or .jpg format, optical character recognition (OCR) or other techniques may be used for example by server 10 to create text to be indexed. Audio or video documents may have additional text metadata added, may have a transcription performed, or may have only certain metadata added by the primary agent indexed. In some embodiments the actions of the primary analyst may cause the document to be entered into database 24, but the document may not be available to end users until the validation agent validates the document. In other embodiments, the document is entered into database 24 when an agent validates the document.

Multiple agents, each analyzing documents of one or more different languages, may create metadata in a standardized form and standardized language that is easily searchable. For example, a set of agents may work in India uploading and validating documents in local languages and formats, and another set of agents may work in Russia uploading and validating documents in Russian, in a different format. End users, for example working in New York and speaking English, may easily search over documents describing corporations, companies, or other organizations from Russia, India, and other countries in a standardized format and language. The metadata may be translated to another language, a language other than that of the original metadata, allowing other users in other countries to have easy access to the data.

Uploading or entering a document may in some cases include an agent listening to a live event (e.g., a conference call, a broadcast), and transcribing all or part (e.g., key points) of the call into metadata or into its own document, representing the event. For example, an agent may listen to and record a conference call, and save an audio recording of the call and text notes or a transcript as one document.

When a document is uploaded, it may be reformatted. Reformatting may not involve altering the document itself, but rather attaching metadata or tags to sections of the document, or associating metadata or tags to sections, to organize the document according to a format standard within server 10. Alternately or additionally, the document may be taken apart and reconstituted.

A calendar function, possibly part of GUI 52, may alert an agent as to when it is expected that certain documents may be released, for example by a certain corporation or by a government agency. In some embodiments, an automated process, possibly executed by server 10 (e.g., a crawler) may periodically access databases or web-sites and determine if a new document exists to be uploaded by an agent, and if so alert an agent (e.g., by GUI 52). For example, an automated process may repeatedly access a website, and may notice a change or addition in a certain section (e.g., “news” or “press releases”), and if so alert an agent.

Agents searching for documents to upload may also contact companies directly, review company websites, or review other databases, such as government databases (e.g., a database operated CVM), or other databases.

### Data Collection Via Automated Agents

In one embodiment, automated software agents such as crawlers (e.g., crawler 28) may be executed by a processor such as for example, processor 56 of computer 50, processor 16 of server 10, and/or another processor, on a different computer system. Multiple instances of the same crawler may operate. For example, in some embodiments, the same “crawler” or body of code may be executed by multiple entities, such as multiple servers 10, to access different databases or websites. These automated agents may gather documents from, for example, government databases or websites, databases or websites operated by a company from which information is desired, or other sources.

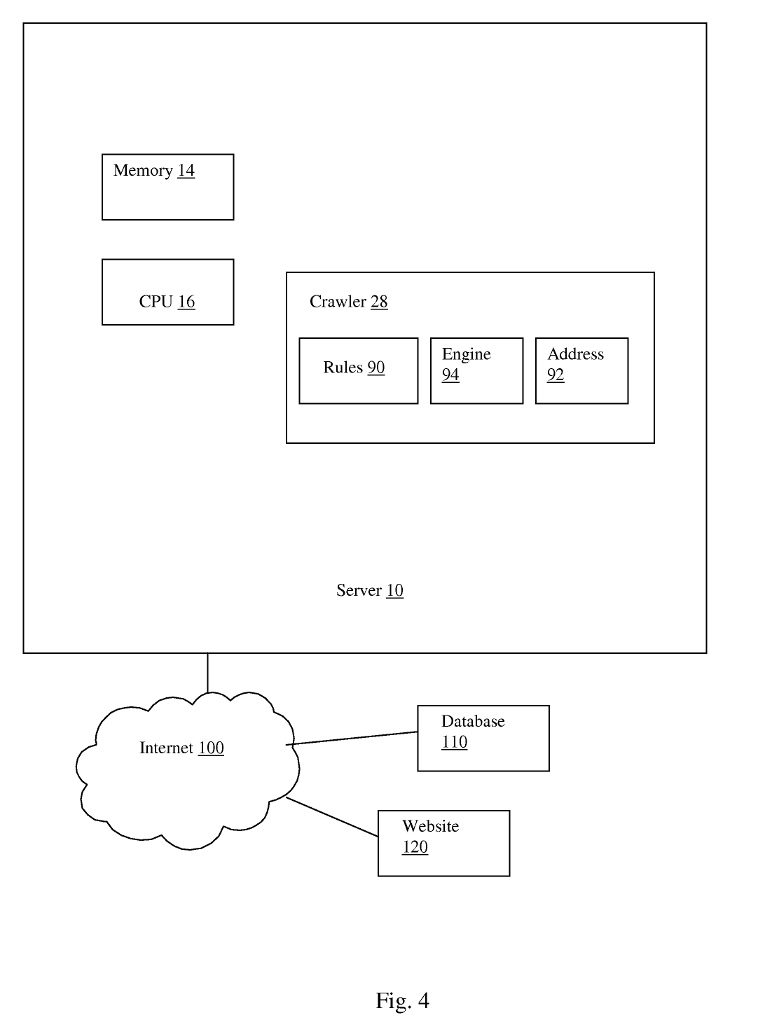

FIG. 4 depicts an automated data gathering module such as crawler 28, according to one embodiment of the present invention. In one embodiment, crawler 28 may be a multi-tiered application or module including, for example, a user facing module or application for allowing an administrator or analyst to interface with the crawler, and a rules engine for processing rules. Crawler 28 may be for example software code stored in part in memory 14, and being executed on a processor such as processor 16. Crawler 28 may be executed by one or many entities such as servers (e.g., as multiple instantiations of crawler 28). In other embodiments crawlers may be stored in other memories and executed on other processors. Crawler 28 may include a set of rules 90 (which in one embodiment may be maintained separately from crawler 28, for example in a relational database in database(s) 24), a rules engine 94 for executing rules, and one or more target address(es) or links 92 for databases (e.g., URLs or other addresses). Crawler 28 may, via a network such as Internet 100, access a remote database 110, a remote website 120, or another data source. Remote data sources such as remote database 110 and remote website 120 may be operated by, for example, servers and processors executing code stored in memory.

Target address 92 may direct crawler to a database (e.g., database 110, website 120) or other data source to access. For example, target address 92 may be a URL. Remote database 110 may be, for example, a financial database operated by a government agency (e.g., the Securities and Exchange Commission (SEC) or the CVM) or another database. Remote website 120 may be for example a website operated by a corporation, company, or other organization, or another website.

Target address 92, and possibly rules associated with the target addresses, may be for example entered by an agent or analyst via a user facing module. For example, an agent or analyst can tag certain web pages as containing specific documents to obtain or specific document types, or belonging to specific companies. Rules of rules 90 may include dates or times for a crawler to access a database or website for certain information. Rules 90 may include data on when a crawler is supposed to visit certain databases or websites for certain information, for example repeatedly, on a one-time basis, or according to another schedule. For example, a company may be identified (by, e.g., an agent or analyst) as having a fiscal year ending in June and thus a rule 90 will prompt a crawler to access a certain website each June 30.

In one embodiment, target addresses 92 may include a list of links which may for example be updated by a user such as an analyst. For example, target addresses 92 may include a starting page or pages. Target addresses 92 may be added as new relevant addresses for databases, websites or web pages are determined, and may be deleted if links are determined to be not relevant or erroneous. Specific rules in rules 90 may be associated with certain links. Pages referred to by addresses 92 may include dates for the crawler to visit, e.g., a company that is identified having a fiscal year ending in June may have a Q4 relevant date of June 30, and the target address or link 92 may indicate a crawler should visit a certain website on this date.

In one embodiment, each crawler 28 is tailored (for example via rules 90), to operate on one data source. In other embodiments crawler 28 may operate on multiple data sources. Rules 90 may allow crawler 28 to handle different data file or document formats that are provided by the same data source. For example a government agency may provide multiple documents on each corporation, company, or other organization for which it maintains data, each document in a different format, for example securities filings including annual reports, quarterly reports, share ownership disclosures, and disclosure of material corporate events. A corporate website may provide different documents in different formats; for example: press releases in text, videos of presentations in .mpg format, audio files, Microsoft PowerPoint files, or other files.

The crawler 28 may access a website or database via known methods, via a network such as the Internet 100. A rule within rules 90 may tell the crawler 28 where in the data source to find a document. If the data source is a website, the crawler 28 may have the capability to navigate within a website, per the rules, to a portion of the website holding the documents relevant to server 10. If the data source is a database, the crawler 28 may have the capability to navigate within the database, possibly using a login, per the rules, to a portion of the database holding the documents relevant to server 10.

The crawler 28 may include a list of entities relevant to the crawler 28 (e.g., in rules 90). For example, a government database may have information on many companies, only some of which server 10 supplies information on to users or customers. When the crawler 28 finds a new document relevant to an entity for which it is to find data, the crawler may access the document, and possibly download the document to a database such as database 24. Based on rules 90, and for example certain data or certain types of data known to appear in certain portions of documents having various types the crawler may determine the document type. For example, the headings of quarterly CVM filings or other filings may be identified as such by the crawler. Based on the document type, the crawler 28 may create metadata, possibly a set of metadata similar in form to that created by an agent or analyst.

The crawler 28 may tag the document or add metadata to the document. For example, the crawler 28 may determine a document's type from, for example, the document format or content, based for example on rules 90. The crawler 28 may determine a date (e.g., or publication, of posting on a website, etc.) for the document. In some embodiments, the crawler 28 may decide how to determine certain metadata (e.g., a date, a title, a set of sections) based on the type or category of the document, the document source, and rules 90. Based on the document type, the crawler may decide how to process the document; this may be done for example based on a decision tree. In some embodiments the crawler may intelligently process a document, rather than simply accessing a web page and accessing a pre-determined set of data. Based on certain information determined by the crawler about a document, the document may be tagged or processed in a certain way.

For example, if the document is determined to be type A, crawler 28 may assume a certain structure and content to the document and process and tag the document accordingly; document type B may result in a different processing. A date may be used to generate part of a title; other metadata, such as the type of document, may be used by crawler 28 to generate a title. For example, in one embodiment, a set of words that, if they occur in the first X sentences or X words of a document, will indicate to crawler 28 that the document is likely a certain type of document such as conference call or news item.

Another example of a rule in rules 90 is that if a crawler 28 obtains two new documents from a database and website that are in two different languages, the crawler 28 may performing a quick mechanical or automatic translation and determine whether or not the documents are the same document in two different languages.

Another example of a rule in rules 90 is that having identified a document as for example a conference call transcript, a crawler 28 may, assisted by its stored knowledge of the company's fiscal year dates, identify the relevant date for the transcript if the date can be found for example in the transcript's first paragraph.

The crawler 28 may tag document sections (e.g., introduction, statement of management, financial data, etc.). Document section tags may allow a user to search text in certain sections of a document. Crawler 28 may break up a document and reformulate or reconstitute the document into a standardized format used by server 10. For example, the document may have its sections reorganized, or may have metadata or other information inserted or removed. In one embodiment, crawler 28 may, based on for example a type of document (e.g., a record type), divide the document into portions, tag each portion with a field identifier from a set of field identifiers, and save the portions as a document in database 24. The tag may be saved for example as metadata in metadata 25.

Crawler 28 may identify itself to a website as a common browser, such as, for instance, the Firefox browser.

A crawler may be capable of extracting documents beyond those that it is pre-programmed to handle.

As with other data finding and uploading methods discussed herein, the document may be in a language or format different from the standard language of the server 10 and metadata used by the server 10. Various versions of crawler 28, each analyzing documents form one or more “assigned” data sources, in different languages, may create documents and metadata in a standardized form and standardized language that is easily searchable. In some embodiments a crawler 28 may be able to analyze different databases or data sources in different languages. E.g., one crawler 28 may operate on a set of entities or organizations from India, uploading and data from the corporation websites, another crawler 28 may be assigned and tailored to access one or more public records databases in India (e.g., via SEBI), and other crawlers 28 may perform similar tasks in Brazil or other countries.

Automated agents may determine if new documents or updated or changed documents appear on sources such as government or company databases or websites, or other sources. For example a crawler 28 may use target address 92 to access a website. In some embodiments, an automated process, possibly executed by server 10 (e.g., a crawler) may periodically access databases or web-sites and determine if a new document exists to be uploaded by an agent or a process. If a new document exists an agent may be alerted (e.g., via GUI 52). For example, an automated process may repeatedly access a website, and may notice a change or addition in a certain section (e.g., “news” or “press releases”), and if so alert an agent.

In some embodiments, a crawler 28, instead of adding or uploading data to server 10, may notify an agent or analyst that a new or revised document is available from a data source. For example, a crawler may update an entry in a calendar function, or alert an agent (e.g., by GUI 52).

In some embodiments the document may be uploaded and/or indexed without verification.

After a crawler 28 uploads a document (and possibly after it is validated), the metadata and possibly the text of the document itself may be indexed, and the indexing data added to for example index 26, as described herein.

In some embodiments a validation process (e.g., via an agent or analyst) may be performed on documents entered via an automated process such as a crawler.

As with other data collection methods described herein, multiple crawlers, each accessing one or more data sources in one or more languages, may upload data to server 10.

### Data Input from Corporate Agents

In one embodiment, entities (e.g., companies or corporations, or other entities) themselves, having documents describing the entity stored by server 10, may upload or post documents to server 10. A company representative may for example enter information, or cause information to be uploaded or entered, via for example input device(s) 79 and view information on monitor 76, via for example GUI 72.

In one embodiment, a person authorized by the corporation, company, or other organization (e.g., a corporate agent) may send an e-mail message or other message to server 10, and in response server 10 may send a unique key back to the person at the e-mail address used to send the message. The e-mail address may be checked before being responded to; e.g., the domain (e.g., the Internet domain name) of the e-mail messages may be verified as being that of the company. The key may be for example a password, although a key may include other security information, such as a certificate, encryption information or devices, etc. In one embodiment, a corporate agent must validate a key, for example within a certain amount of time (e.g., 24 hours). In addition to other permissions and restrictions, a representative of a corporation may, after logging in, only access, modify, or upload data relevant to that corporation.

GUI 72, possibly executed on computer 70 but controlled or provided by server 10, may interface with a corporate agent or representative to allow the representative to enter or upload data and view data as discussed herein. For example, GUI 72 may present data such as login request information or an information page for the corporation, company, or other organization, and may accept from the agent data such as documents to upload (or links to documents), metadata, corrections or suggestions to metadata, etc. GUI 72 may transfer data to and from server 10 via a network such as Internet 100.

A corporate representative may, after logging in, view the same or a similar set of data, or page(s) of data, that a user subscribing to a service provided by server 10 may see when requesting data about the corporation.

A corporate representative may, after logging in, suggest to server 10 that a certain document is to be uploaded to the server 10. In one embodiment, when this suggestion is received, server 10 may have an agent or analyst working for the organization operating server 10 (e.g., an upload analyst) accept the document as uploaded by the corporate agent, or obtain the document from the data source referenced by the corporate agent, and continue the upload process as described herein with respect to the upload analyst. In another embodiment, server 10 (e.g., via a GUI, possibly similar to that described herein with respect to upload analysts) may allow the corporate agent to upload the document and add metadata, in a process similar to that performed by upload agents, described herein. Validation may or may not be performed (e.g., by a validation analyst) on a document uploaded by a corporate agent.

A corporate agent representative may, after logging in, correct data, or make suggestions to server 10, to correct data relating documents relevant to (or stated to be relevant to) that corporation, for example to correct metadata, to recategorize (or re-“type”) a document, or possibly to remove a document. In one embodiment, a corporation may correct the data itself (e.g., via an agent working for the corporation). In another embodiment, a corporation may suggest corrections to the data, which may then be effected by agents or analysts working with or for the organization operating server 10 (e.g., upload analysts or validation analysts).

After a company agent uploads a document (and possibly after it is validated), the metadata and possibly the text of the document itself may be indexed, and the indexing data added to for example index 26, as described herein.

In one embodiment, a corporate agent may validate or mark valid a document uploaded for that corporation by an agent of that corporation.

### User Access of Data

A GUI such as GUI 32, executed by computer 32 and supported or generated by server 10, may allow an end user, client or customer to search over and access, using one language and one standard format and system, information such as documents 31 stored in database 24. A user may enter information via for example input device(s) 39 and view information on monitor 38. These documents may be in various languages, collected from various different countries, in various different formats, with different types of original metadata. In one embodiment, when summary information for a document is displayed on a screen to a user, an indication of the language of the document (e.g., PT for Portuguese) may be displayed with the summary information. GUI 32 may be for example executed by a web browser. A user may be required to log in using for example an identification and password before accessing data or searching. GUI 32 may be adapted to interface with users in a set of languages, not necessarily related to the languages of documents 31, or the language(s) of the metadata.

In one embodiment, an end user is a customer of the organization operating server 10. For example, an individual, or an entity such as a pension fund, mutual fund, or investment bank, may have an account with an organization operating server 10. The individual or a user within the entity may access server 10, via computer 30, to obtain or view documents among documents 31 relating to corporations, companies, or other organizations. Various pricing models, such as subscription, time, or per-document, may be used. In other embodiments, a user need not be a customer.

In some embodiments, metadata created in a certain language, by or for server 10, may be translated to another language so that users fluent in a language other than the standard language used by server 10 may use to search over documents 31, for example using index 26′.

A user may enter the name (or partial name) of a corporation (for example into GUI 32), and a listing or summaries of all documents in database 24 relevant to that corporation may be displayed, for example on a “company page”. These documents may be organized by document type, or another method. Only the most recent documents may be displayed in each category or type, to enable the lists to fit on one screen. In some embodiments, a page or pages displaying data relevant to a company may include the look and feel of, or logo of, the company. This may be done, for example, if the company pays a fee to the organization operating server 10. By selecting (e.g., clicking on the screen representation of the summary using an input device 39) the summary or listing of the document, the full document may be displayed to the user via GUI 32.

A user may, for example via GUI 32, enter a set of search terms in for example a search box displayed on GUI 32, using for example standard search engine protocols, and search over all or a designated portion of the documents in database 24. The search may be over, for example, index 26. Documents which, when listed within search results, receive many requests to view the document, may be “bumped up” or raised in rankings in subsequent search results. A listing or set of summaries of documents may be displayed in the search results. By selecting a document, the full document may be displayed. In some embodiments, a user can download a document to save a copy locally, for example on user computer 30.

As discussed, the user may have searched using the user's native language, but the document selected may be in a different language. When selecting to view a document, the user may be presented with the option of having the document translated from its original language. A button or indicator may be provide by GUI 32 which, when pressed (e.g., using a mouse) by a user, causes the document to be translated.

In one embodiment, the user may have options between translation types, such as machine translation and human translation. A machine translation, such as statistical machine translation, may be performed, and the resulting text provided to the user.

In the case the user chooses a human translation, a message (e.g., e-mail) may be sent to an administrator or translation service, and the translation may be performed by a human translator.

In one embodiment, a machine translation is provided at no cost, but a human translation requires the user to pay a fee. Other pricing schemes may be used. The first user requesting the translation may be charged the full cost of the human translation. The translation of the document is saved in documents 31, possibly with the document, so that another translation does not need to be performed.

Alternately, a set of users, for example the first X users, may be charged for the translation, the fee for each user a fraction of the total fee for the translation, for example the total fee/X. X may be determined based on the estimated demand or popularity of the document. The demand or popularity may be estimated, for example, based on the size of the company related to the document, the type of document, the country, and/or other factors. X may be set relatively high for a document with high estimated demand, and thus the cost to the first X users may be lower. In some embodiments, the X+1th user (and users after that) to request a translation is not charged. In other embodiments, all users requesting the translation are charged. In further embodiments, X is determined to calculate a price, but X+N users are charged.

For example, a user may want to search for any company in the countries which are supported by server 10 (e.g., in one embodiment, Brazil, Russia, India or China) that conducts business in soy bean production, distribution, or supply. The user may enter “soy bean” in a search box and view a page listing summaries of documents, possibly sorted by relevancy, corresponding to this search. The user may also be presented with filters and search suggestions for refining the search. A user may enter “Brazil” and “soy beans” in a search box and be shown a page displaying a list of all documents corresponding to this search.

A user may be given a choice, via for example GUI 32, of whether to view documents by company (by entering a company name) or by searching over all documents relating to all companies supported by server 10. Other data search or data access methods may be used.

Typically, data in index 26 is in one standard language—e.g., English (although other standard languages may be used). Due to the nature of language, some small portion of the data may vary from the standard language (e.g., be non-English) due to imported phrases and names. The language used for index 26 may be the same language as the language used for the interface to server 10—e.g., the languages displayed in the various GUIs produced by server 10. In some embodiments, as index 26 is created, or at another time, a parallel index 26′ may be created, in another language, in order to allow users fluent in the other language to more easily search over index 26, by searching over index 26′. The translation may be, for example, a machine translation. In one embodiment, statistical machine translation may be used.

Embodiments of the invention may include an article such as a computer or processor readable medium, or a computer or processor storage medium, such as for example a memory, a disk drive, or a USB or other flash memory, encoding, including or storing computer readable instructions which when executed by a processor or controller, carry out methods disclosed herein. In some embodiments of the invention, methods discussed herein may be carried out by a processor (e.g., one or more of processors 16, 36, 56, or 76) executing code stored in memory (e.g., one or more of memories 14, 34, 54, 74) or another storage medium. While specific structures and hardware are discussed herein (e.g., server 10), embodiments of the invention may be carried out by systems having other structures.

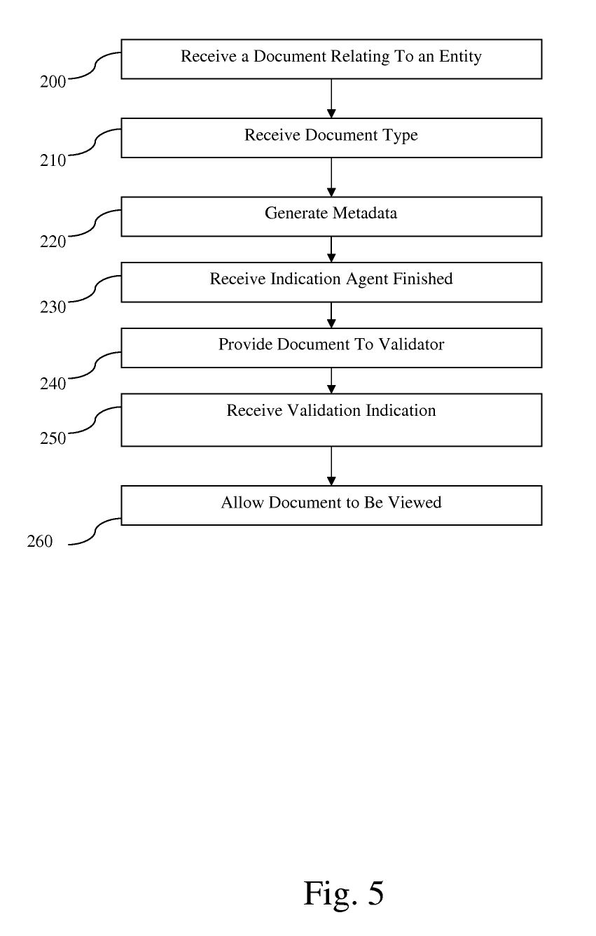

FIG. 5 is a flowchart of a method for agents or analysts to populate a database with documents and verify the documents according to one embodiment of the invention. In operation 200, a database holding financial information from multinational sources, for example maintained at a server, may receive a document relating to an entity such as a company or corporation. The database or server may receive the document from a human agent such as an analyst (e.g., an upload analyst).

In operation 210, the database or server, or a graphical interface, may display or provide a list of document types or categories, and may receive from the agent a selection of a document type or category for the document.

In operation 220, the server or database may generate, for example at a user interface, metadata for the document. In one embodiment, the metadata may include for example a title for the document. The title may be generated at least in part from information known about the document such as the document type and document date, or other data.

In operation 230, the server or database may receive, for example at the user interface, an indication that the agent is finished inputting the document.

In operation 240, the server or database may provide, for example via a user interface, the document and the metadata to a different agent or analyst, such as a validation agent, typically a human. The agent may check the document and metadata for validity.

In operation 250, the server or database may receive, for example at the user interface, an indication of validation of the metadata entered by the uploading agent. For example, a validation agent, after reviewing a document and metadata, may determine that the document and metadata is correct or suitable, and may validate the document by, for example, providing an indication on a user interface.

In operation 260, the server or database may, after receiving the validation indication, allow the document to be viewed by an end user (e.g., a customer of the organization operating the server). The document may be in a database containing documents relating to corporations in a plurality of countries, the documents in a plurality of languages, and the user may access the document via the database.

Other operations or series of operations may be used.

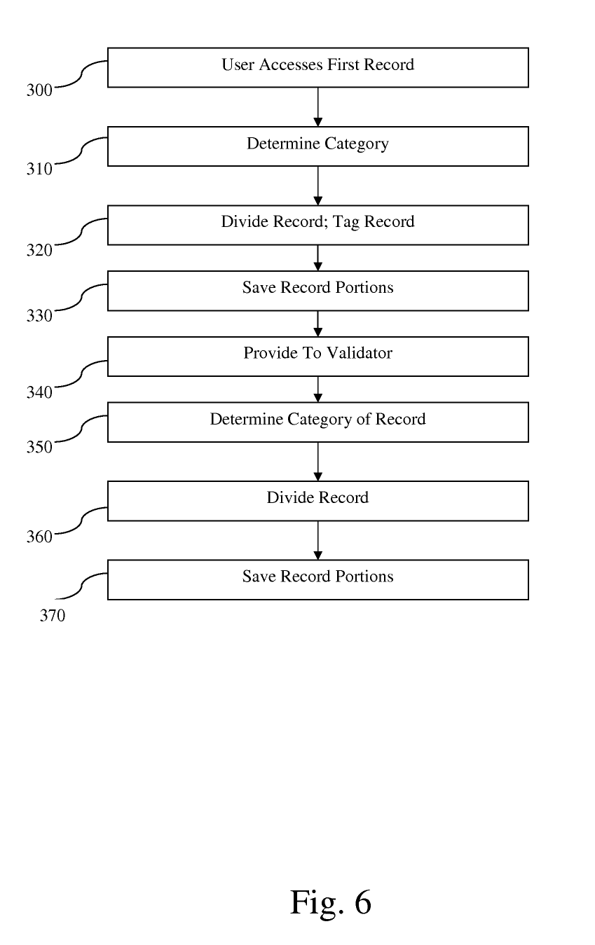

FIG. 6 is a flowchart of a method for attaching metadata to documents maintained by a server maintaining a financial database according to one embodiment of the invention. In operation 300, a user (e.g., an agent or analyst) operating a computer (e.g., an agent or analyst computer) or terminal may access a record or document in a remote database holding financial information which may be held by another computer. The remote database may be for example a source of general financial information for a country, such as a government database, a website operated by a company having information on that company, or another database.

In operation 310, at the computer, the record or document may be read to determine its record type or category. This operation may be performed, for example, by a user operating the computer, but alternately may be done, for example, automatically.

In operation 320, at the computer, the record may or document be divided into portions, for example based on the first record type or category, and each portion tagged or marked with a field identifier or section marker from a set of field identifiers, section markers or other metadata. Metadata in addition to field identifiers or section markers may be used.

In operation 330, at the computer, portions may be saved in (e.g. by being sent to) a remote financial database holding documents from multinational sources, maintained for example at a server. Typically, regardless of the language of the record and the remote database, the field identifiers and metadata are in a standard language.

In operation 340, at another computer (possibly located in a different country than the first computer), a second remote database record, maintained at a computer or server different from the one accessed in operation 300, may be read.

In operation 350, at the other agent or analyst computer, the record may be read to determine its record type or category.

In operation 360, at the agent or analyst computer, the record may be divided into portions, for example based on the record type or category, and each portion tagged or marked with a field identifier from a set of field identifiers, or other metadata.

In operation 370, at the computer, portions may be saved in (e.g. by being sent to) the remote financial database.

While each of the two records processed may be documents in different languages, from different countries, in different original formats, the metadata attached to the data when saved in the financial database maybe in on standard language.

Other operations or series of operations may be used.

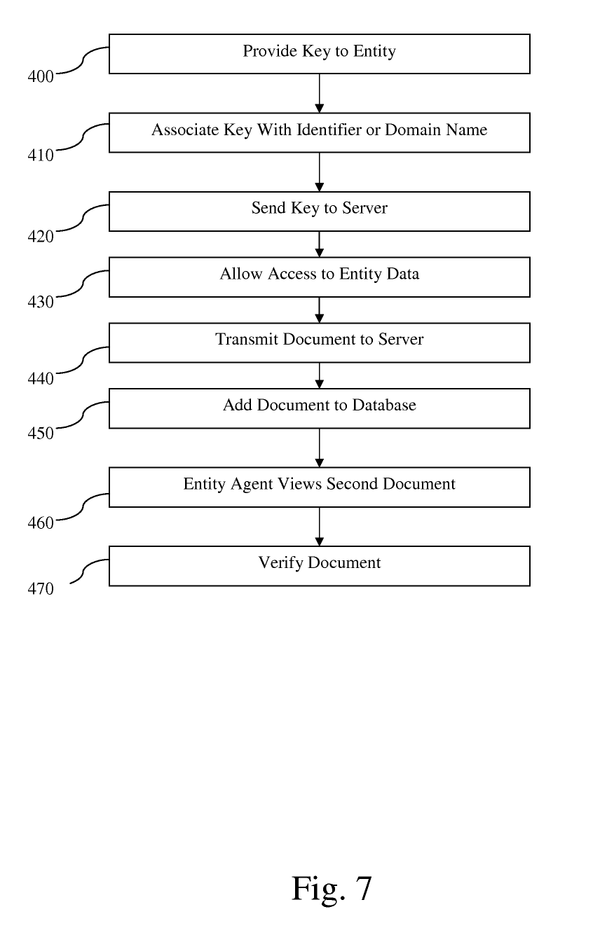

FIG. 7 is a flowchart of a method of allowing a corporate or other entity representative to upload and verify documents in a database of financial records, according to one embodiment of the invention. In operation 400, a computer system or server (for example a server maintaining a database of financial information from multinational sources) may provide (e.g., via a network such as an Internet) to a representative of a corporation a key.

In operation 410, the server or computer system may associate, at a computer system, the key with an address or identifier, such as an Internet domain name assigned to the corporation. For example, the key and domain name, and other information related to the account of the corporation, may be saved in a database at the server.

In operation 420, an agent or representative of the corporation may wish to access documents relating to the corporation at the server, and the agent may send to the server, and the server may receive, the key.

In operation 430, if the key is received via a communication channel associated with the domain name associated with the key, the agent may be allowed to access data relating to the corporation. For example, in operation 440, the agent may be allowed to transmit to the server a document relevant to the corporation. If the verification of the agent is unsuccessful no access will be allowed.

In operation 450, if verified the document may be added to the database maintained by the server or, after verification the document may be permissioned so it may be accessed by other users.

The server may maintain numerous documents relating to the corporation, and to other corporations. Agents of the corporation may be allowed to validate documents uploaded to the server by other methods, such as crawlers or upload analysts. In operation 460, the corporate agent may be allowed to view a second document maintained by the computer system, the second document being uploaded by a first analyst and the second document having been sent to a second analyst for verification.

In operation 470, the corporate agent may verify the document, possibly in place of a verification agent. For example, if the corporate agent sees that the document is appropriate, related to the corporation, and contains or is attached to the correct metadata, the agent may send to the server and the server may receive from the user, before the second analyst verifies the second document, an indication that the second document and metadata attached to the second document is accurate.

Other operations or series of operations may be used.

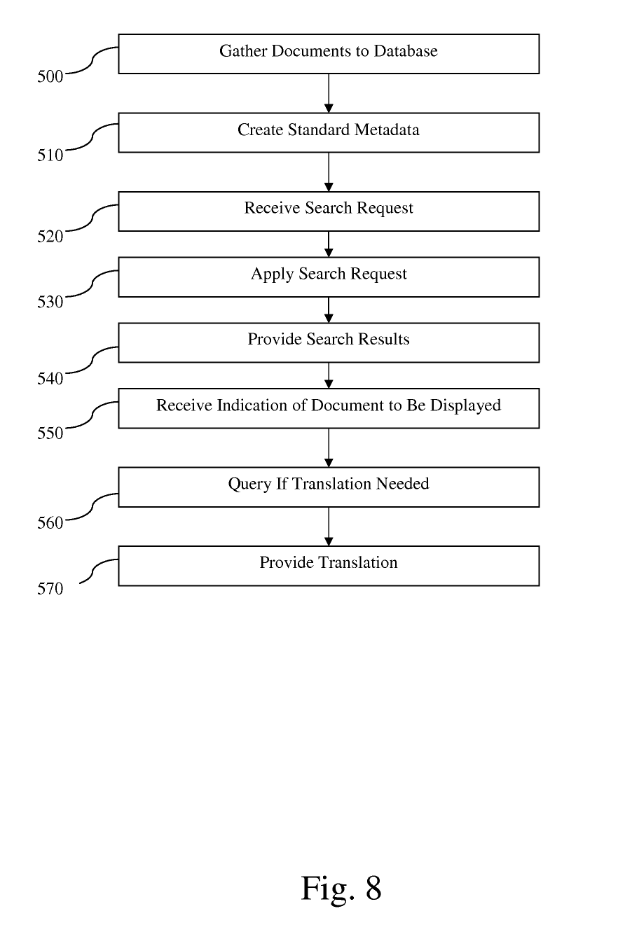

FIG. 8 is a flowchart of a method of allowing a user, such as a customer subscribing to a financial documents service, to access documents in a database of financial records, according to one embodiment of the invention.

In block 500, documents may be gathered by, for example, human agents or analysts and/or automated processors such as web-crawlers, and received at a database for example maintained by a server. Other methods of gathering documents or files, such as allowing companies or other entities to enter documents into a database, may be used. The documents may include for example files or documents relating to a number of entities such as corporations, and each of the documents may be written in one of a number of different languages.

In block 510, for each document, a set of metadata may be created in one standard language.

In block 520, the server, database, or other entity may receive, e.g. via a user interface operated by a computer remote from the database, a search request from a user. The search request may being in the standard language used for the metadata in operation 510.

In block 530 the search request may be applied to the metadata. For example, a search may be performed on the metadata using for example a search engine to provide search results.

In block 540, a list of documents matching the search results may be provided to the user, for example via the user interface.

In block 550 the server, database, or other entity may receive an indication from the user (for example via the user interface) of a document to be displayed.

In block 560, if the requested document is in a language other than the standard language of the metadata, the server, database, or other entity may query the user (for example via the user interface) if the user wants a translation.

In box 570, if the user indicates, for example via the user interface, that the user wants a translation, a computer-generated translation may be created and provided to the user.

Other operations or series of operations may be used.

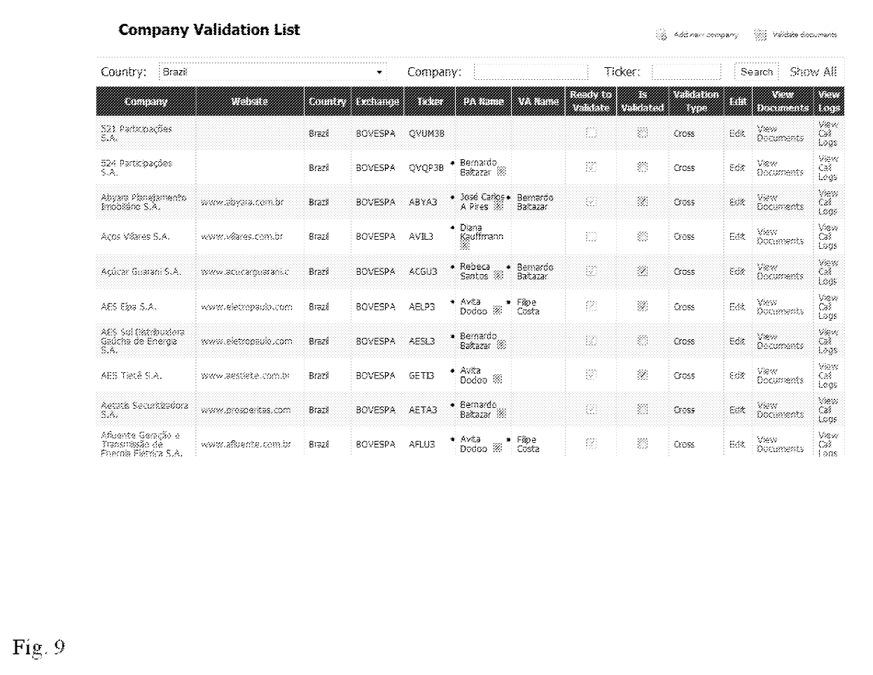

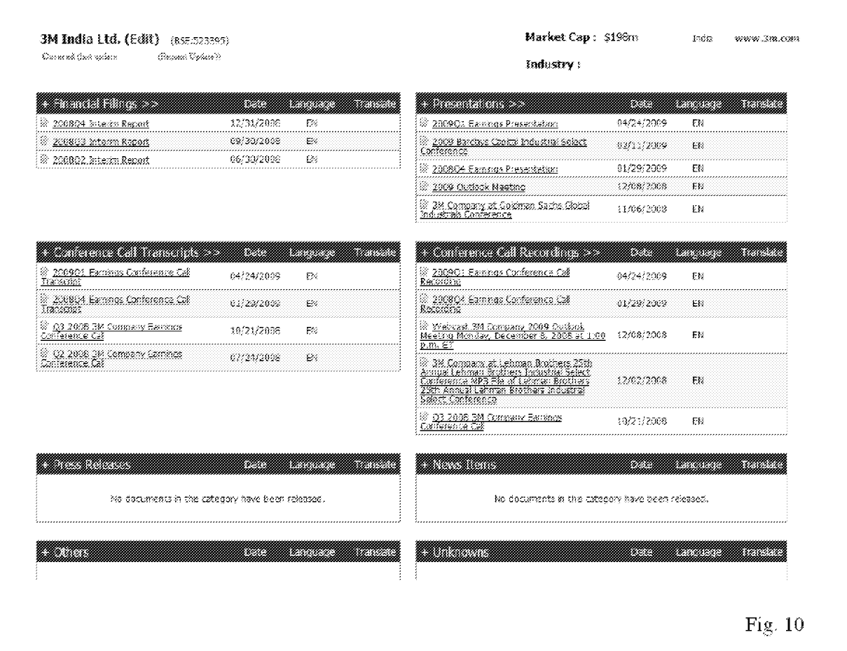

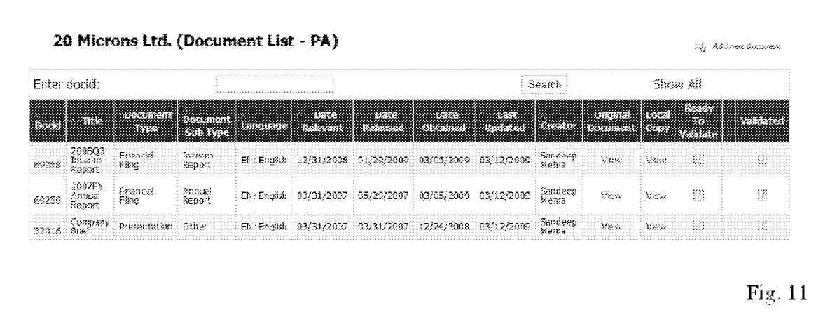

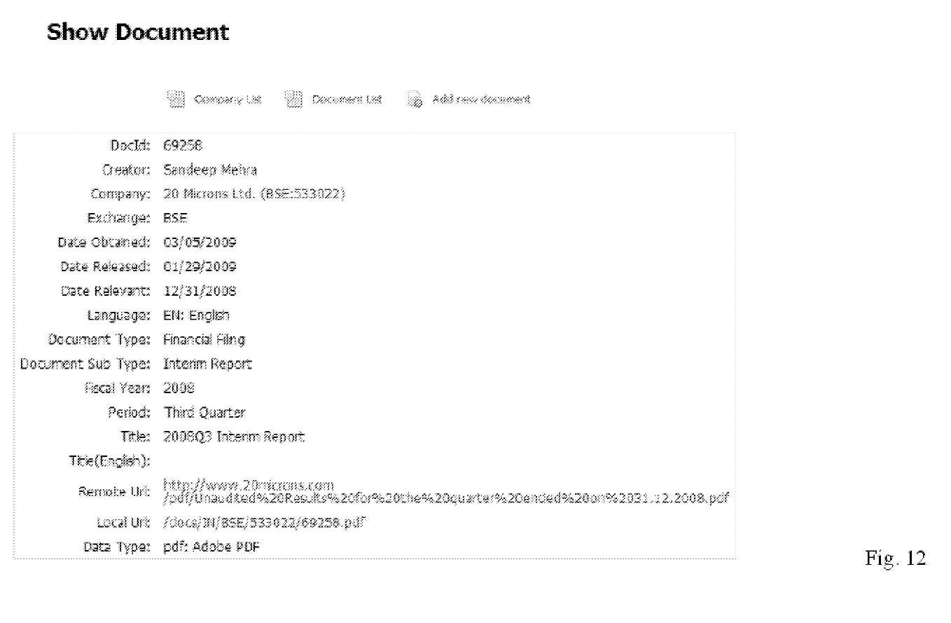

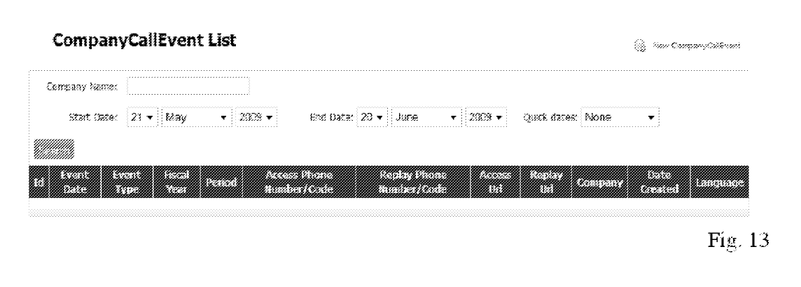

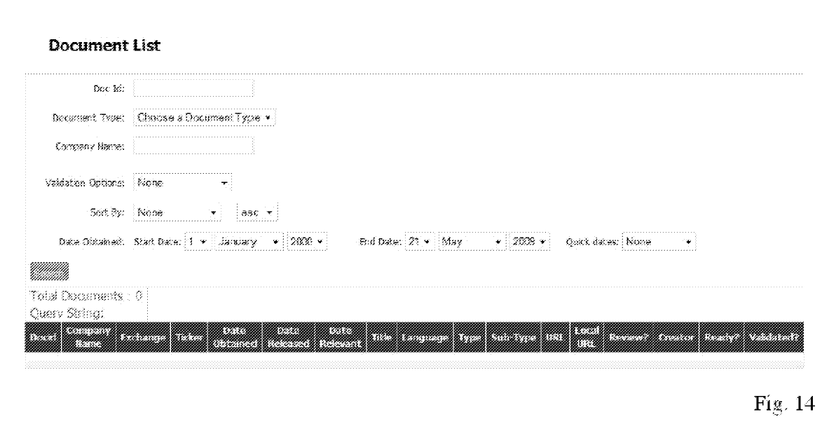

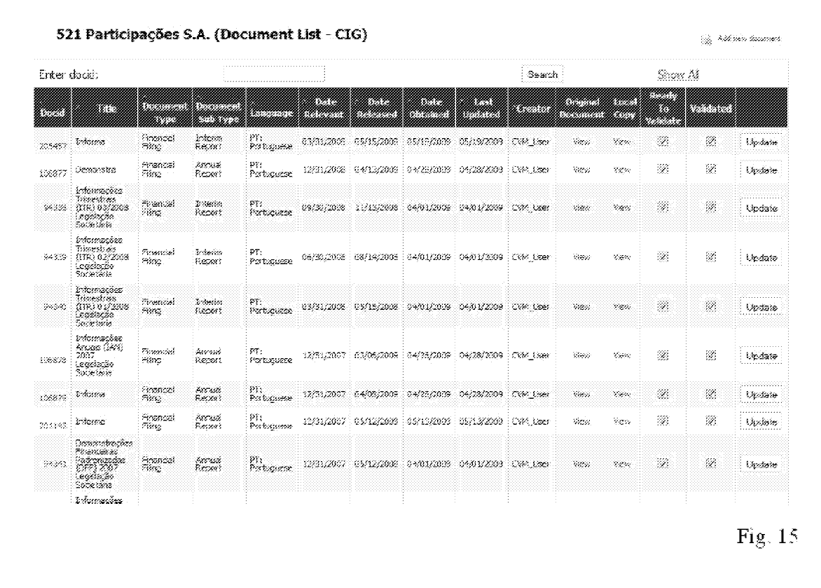

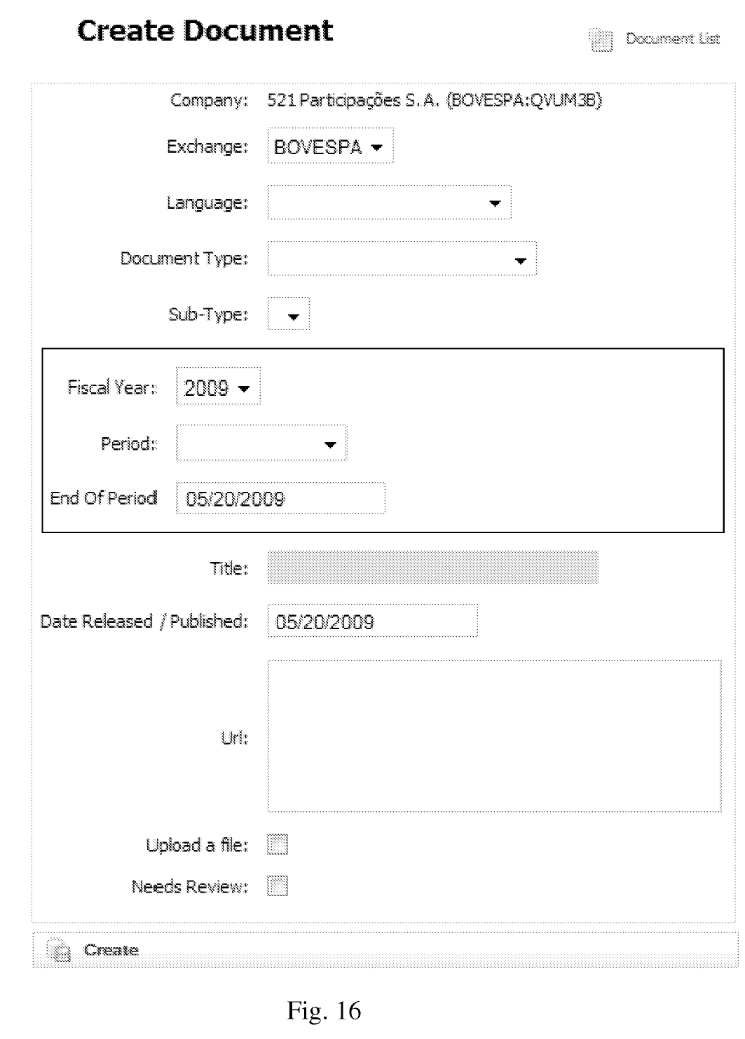

FIG. 9 is a screenshot showing a GUI that may be presented to a primary analyst or verification or validation analyst, according to an embodiment of the invention. FIG. 10 is a screenshot showing a GUI that may be presented to a user, such as a company representative (or an agent working for an organization operating a server), showing documents relevant to that company, according to an embodiment of the invention. FIG. 11 is a screenshot showing a GUI that may be presented to an agent or analyst working for an organization operating a server, showing documents relevant to a specific company, according to an embodiment of the invention. FIG. 12 is a screenshot showing a GUI that may be presented to a user (e.g., a primary analyst) information (e.g., metadata) relating to a document according to an embodiment. FIG. 13 is a screenshot showing a GUI that may be presented to a user (e.g., an analyst) showing events related to a company according to an embodiment. FIG. 14 is a screenshot of a search tool allowing agents or other users to search documents, for example documents for which the agents are responsible for, according to an embodiment of the invention. FIG. 15 is a screenshot showing a GUI that may be presented to an agent or analyst working for an organization operating a server, showing documents relevant to a specific company, according to an embodiment of the invention. FIG. 16 is a screenshot showing a GUI that may be presented to a primary analyst when creating or inputting a new document, according to an embodiment of the invention.

It will be appreciated by persons skilled in the art that the present invention is not limited to what has been particularly shown and described hereinabove. Rather the scope of the present invention is defined only by the claims, which follow:

1. A method of inputting data into a database of financial information from multinational sources, the method comprising:
receiving at a database, from a first human agent, a document relating to a corporation;
providing, at a user interface, a list of document types, and receiving, from the first agent, a document type for the document and a document date for the document;
generating at a user interface, metadata for the document, the metadata comprising a title, the title generated at least in part from the document type and document date;
receiving at the user interface, an indication that the first agent is finished inputting the document;
providing, via a user interface, the document and the metadata to a second agent;
receiving, at the user interface, an indication of validation of the metadata entered by the first agent; and
after receiving indication of the validation, allowing the document to be viewed by a user via the database, wherein the database contains documents relating to corporations in a plurality of countries, and wherein the database contains documents in a plurality of languages.

2. The method of claim 1, wherein the database comprises information on a plurality of corporations, the method comprising:
the user interface permitting the first agent to enter information relating to a first subset of corporations and to validate information relating to a second subset of corporations, the first subset and second subset being non-intersecting; and
the user interface permitting the second agent to enter information relating to a third subset of corporations and to validate information relating to a fourth subset of corporations, the third subset and fourth subset being non-intersecting; wherein the first subset and fourth subset partially intersect.

3. The method of claim 1, comprising, after the indication that the first agent is finished is received, notifying the second agent that the document is ready for validation.

4. The method of claim 1, wherein a portion of the metadata is in a first language which is different from the language of the document, the method comprising translating the metadata to a second language and presenting the metadata to a user in the second language.

5. The method of claim 1, comprising, at a computer, an automatic process:
searching a remote computer database;
finding a second document;
creating metadata for the second document; and
entering the second document and the metadata for the second document in the database of financial information.

6. A method of inputting data into a database of financial information comprising documents from multinational sources, the method comprising:
receiving from a first human agent, a first document and metadata relating to the first document, the document being in a first language and relating to a first entity in a first country;
receiving an indication that the first agent is finished inputting the first document;
providing the first document and the metadata relating to the first document to a second agent;
receiving an indication of validation of the first document and the metadata relating to the first document;
entering the first document into a database and creating in the database index information for the first document in a standard language;
receiving from a third human agent, a second document and metadata relating to the second document, the document being in a second language and relating to a second entity in a second country;
receiving an indication that the third agent is finished inputting the second document;
providing the second document and the metadata relating to the second document to a fourth agent;
receiving an indication of validation of the second document and the metadata relating to the second document; and
entering the second document into the database and creating in the database index information for the second document in a standard language.

7. The method of claim 6, wherein the database comprises information on a plurality of corporations, the method comprising:
at a user interface permitting the first agent to enter information relating to a first subset of corporations and to validate information relating to a second subset of corporations, the first subset and second subset being non-intersecting; and
at the user interface permitting the second agent to enter information relating to a third subset of corporations and to validate information relating to a fourth subset of corporations, the third subset and fourth subset being non-intersecting; wherein the first subset and fourth subset partially intersect.

8. The method of claim 6, comprising, after the indication that the first agent is finished is received, notifying the second agent that the first document is ready for validation.

9. The method of claim 6, wherein a portion of the metadata is in a language which is different from the first language, the method comprising translating the metadata relating to the first document to a third language and presenting the metadata to a user in the third language.

10. The method of claim 6, comprising, at a computer, an automatic process:
searching a remote computer database;
finding a third document;
creating metadata for the third document; and
entering the third document and the metadata for the third document in the database.

11. A system comprising:
a database of financial information from multinational sources; and
a controller to:
receive, from a first human agent, a document relating to a corporation;
provide, at a user interface, a list of document types, and receiving, from the first agent, a document type for the document and a document date for the document;
generate at a user interface, metadata for the document, the metadata comprising a title, the title generated at least in part from the document type and document date;
receiving at the user interface, an indication that the first agent is finished inputting the document;
provide, via the user interface, the document and the metadata to a second agent;
receive, at the user interface, an indication of validation of the metadata entered by the first agent; and
after receiving indication of the validation, allowing the document to be viewed by a user via the database, wherein the database contains documents relating to corporations in a plurality of countries, and wherein the database contains documents in a plurality of languages.

12. The system of claim 11, wherein the database comprises information on a plurality of corporations, wherein:
the user interface permits the first agent to enter information relating to a first subset of corporations and to validate information relating to a second subset of corporations, the first subset and second subset being non-intersecting; and
the user interface permits the second agent to enter information relating to a third subset of corporations and to validate information relating to a fourth subset of corporations, the third subset and fourth subset being non-intersecting; wherein the first subset and fourth subset partially intersect.

13. The system of claim 11, comprising, after the indication that the first agent is finished is received, notifying the second agent that the document is ready for validation.

14. The system of claim 11, wherein a portion of the metadata is in a first language which is different from the language of the document, the method comprising translating the metadata to a second language and presenting the metadata to a user in the second language.

15. The system of claim 11, comprising a computer, the computer comprising:
a memory to store a set of addresses of remote databases; and
a processor to execute an automatic process to:
access a remote computer database based on the set of addresses;
find a second document;
create metadata for the second document; and
enter the second document and the metadata for the third document in the database.
